(19) United States
(12) Patent Application Publication
(10) Pub. No.: US 2023/0294802 A1
(43) Pub. Date: Sep. 21, 2023

(54) MODULAR SPACE UNIT FOR BUILDING IN OCEAN, SEA OR WATER BODIES

(71) Applicant: Tat Mun WAN, Singapore (SG)

(72) Inventor: Tat Mun WAN, Singapore (SG)

(21) Appl. No.: 17/922,383

(22) PCT Filed: Apr. 29, 2020
(86) PCT No.: PCT/SG2020/050259

§ 371 Date: Oct. 31, 2022

(51) Int. Cl. B63B 73/20; E04B 1/348; E02D 29/09; E02D 29/045; B63B 73/40

(52) U.S. Cl. CPC B63B 73/20; E04B 1/34815; E02D 29/06; E02D 29/045; B63B 73/40; B63B 2035/4426

(57) ABSTRACT

An idea to use prefabricated modular space unit (FIG. 1) that can be used singularly or combined in plurality (FIG. 2) to form mega floating or underwater architectural buildings & civil structures and support systems for human civilisation. This patent discloses a nova idea to define a standard building system and disclosure of an invention (1) and methodology (2) claims herein to support the nova idea to define a building standard system term as “Modular Space Unit” aka. “The invention” for building in the ocean, sea & water bodies for human civilizations. (3)

### BACKGROUND

This patent discloses a nova idea to define a standard building system and disclosure of an invention (1) and methodology (2) claims herein to support the nova idea to define a building standard system term as “Modular Space Unit” aka. “The invention” for building in the ocean, sea & water bodies for human civilizations. (3)

### INTRODUCTION

An idea to use a prefabricated space unit that can be modular (4) can be connected on 1 or more sides (5), to one another (6) and can be infinitely connected (7) to same or different size (8), shape (9) units. This modular space unit can be made of any materials (10) or combination of different materials for different applications (11) and designed to be easily deployable anywhere.

The purpose of this idea & invention is to use modular units of the invention to create enclosed space/s or open land areas (12) using prefabricated modular space units (13) as building blocks modules (14) anywhere for any purposes (15) in the ocean, sea, pond and any water body applications (16). This invention can also be placed or deployed on solid land or semi solid land materials (17), fully underground (18), semi underground (19), under water (20), semi underwater (21), or anchored (22).

The modular space unit can be structural, like using a space frame structure (23) or aesthetical in design or a combination of both (24) to achieve the desired application.

The idea-manifested invention of a 3 dimensional object (25) of this modular space unit when combined or as a single unit can be airtight (26), watertight (27), or both.

The idea-manifested invention of a 3 dimensional object of this modular space unit can be designed to adapt to any environment (28) desired. One of the main criteria of this nova idea is that this modular space unit aka. The invention can be customized (29) and connected together limited only by its design (30).

The idea-manifested invention of a 3 dimensional object of this modular space unit can have build in connections of support systems (31) and utilities like Air/Oxygen, electricity, waste treatment, renewable energy systems, lights, temperature control systems and goods delivery systems & accessibility systems incorporated.

The idea-manifested invention of a 3 dimensional object of this modular space unit can be sequentially connected (32), subsequently connected (33) and replaced when necessary.

### DESCRIPTION

An idea to build a human civilization manifest the
(1) Invention of prefabricated space units that can be describe as having structures that forms 3 dimensional geometrical shapes like cubes, cuboid, cylindrical, hexagonal prism, pentagonal prism, ellipsoid, dodecahedron, icosahedron, etc. This invention is not constraint to only these shapes.
(2) Methodology describe the way the particular manifested invention can connect to each other (32) (33).
The invention can be connected by means of any fastening methods used now and to be subsequently developed without constraints.
(3) Describe the idea of defining a building standard for using manifestations of the idea aka. The invention (1).
(4) A single module of the invention can be attached and connected to another even if the size and shape may be different.
(5) The invention can be attached, connected on 1 or more of its sides with multiple modules of the invention.
(6) The invention can be attached, connected to each other with multiple modules of the invention.
(7) The invention can be infinitely attached, connected to each other with multiple modules of the invention.
(8) The size of the invention is not fix and dependent on the applications, purpose and use.
(9) The shape of the invention is not fix and dependent on the applications, purpose and use.
(10) The material of the invention is not fix and dependent on the applications, purpose and use.
(11) The material or combination of different materials of the invention is not fix and dependent on the applications, purpose and use.
(12) The invention defines the space enclosed within. When multiple units of the invention are connected, the defined space within increase accordingly. The surface of the invention if usable and can be traversed on are define as open landed space.
(13) Each unit of the invention can be prefabricated to specifications and modular in design so as to ensure ease of deployment, transport, quality control and speed of production, etc.
(14) The invention as describe herein can be used as building blocks connected/attached together to be constructed into architecture structures for human civilization.
(15) The invention can be designed to be deployed anywhere and its functions can be designed to accommodate any purposes or technologies for the benefits of human civilisation.
(16) Although the idea is to construct spaces in the ocean, seas or water bodies. This does not form any constraints for the invention to be used anywhere else.
(17) In relation to (15), the invention can be designed, constructed and deployed and adapted to land, marshland, wetlands and sandy area.
(18) In relation to (15), the invention can be designed, constructed and deployed and adapted to underground on land or under any water bodies.
(19) In relation to (15), the invention can be designed, constructed and deployed and adapted to partially below land and partially exposed above land.
(20) In relation to (15), the invention can be designed, constructed and deployed and adapted to underwater like under the sea level.
(21) In relation to (15), the invention can be designed, constructed and deployed and adapted to float on water. Hence, partially submerge and partially above water level.
(22) In relation to (15), the invention can be designed, constructed and deployed to be anchored via any means to the seabed, bedrock, and ground for stability and/or positioning purposes on any axis.
(23) As describe in (1), the invention can be structurally designed like a space frame.
(24) As describe in (1), the invention can be structurally designed like a space frame while part of the invention members can be also there for aesthetical purposes.
(25) As describe in (1).
(26) As describe in (2), the seal between the connected/attached/combined modular units can be airtight.
(27) As describe in (2), the seal between the connected/attached/combined modular units can be watertight.
(28) As describe in (15), (16), (17), (18).
(29) As describe in (8), (9), (10), (15), (16).
(30) As describe in (2), (4), (5), (6), (7).
(31) The invention can have build in support systems for the building, dwelling, urban systems for human civilisation.
(32) The invention can be sequentially connected in way that multiple modules of the invention can be connected one after another in sequence to achieve a larger structure.
(33) The invention can be subsequently connected in way that additional modules of the invention can be additionally connected to existing structures previously build up with modules of the invention.

I claim:

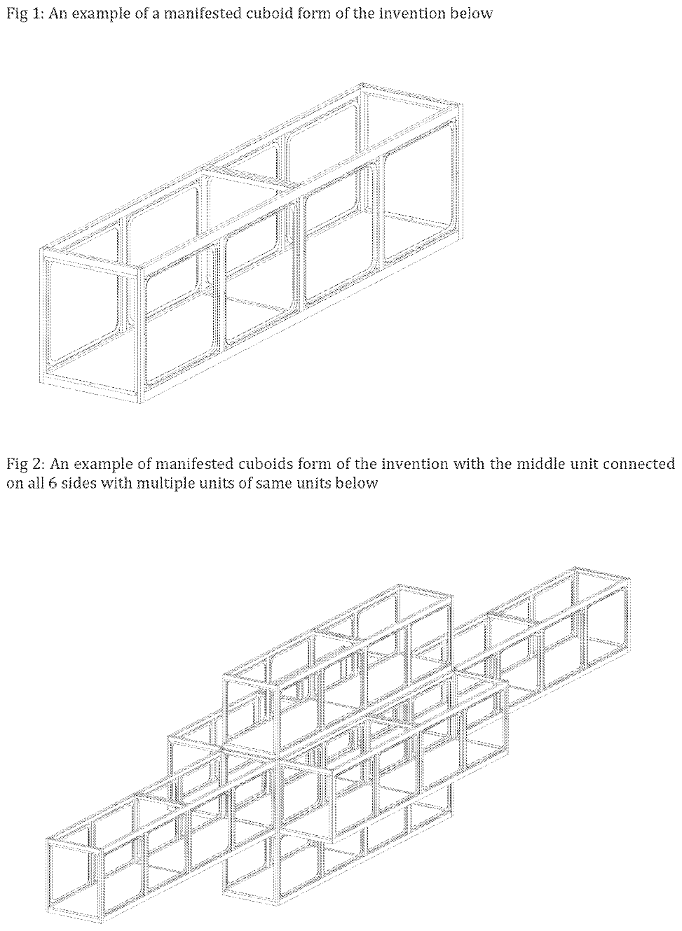

1. An invention of a 3 dimensional geometrical structural space unit that forms part of a whole building systems for building in the ocean, sea or water bodies for building without limits for as long as units of the invention are available (FIG. 1).

2. That the invention can be design like any 3 dimensional geometrical shapes like cubes, cuboid, cylindrical, hexagonal prism, pentagonal prism, ellipsoid, dodecahedron, icosahedron, etc. This invention is not constraint by only these shapes. Also as describe in (1), (23), (24), (30).

3. The methodology in that the invention can be connected in an airtight and watertight manner not limited to methodologies like the use of seals and gaskets. Also as describe in (26), (27).

4. The invention is a manifestation from the disclosure of a nova idea to invent a building system for a realising habitable human civilisation and functions in the ocean, sea, and water bodies. Also as describe in (30).

5. The invention can be connected to each other on 1, any or all of its sides as designed and required (FIG. 2). Protrusions and indentations on connecting surfaces can exist for the purpose of alignment when connecting to each other. Also as describe in (4), (5), (6), (7), (30).

6. The invention can be of any size and shape as designed and required. Also as describe in (8), (9), (30).

7. The invention can be made of any material or combination of materials for its structural members, non-structural members, aesthetic parts, enclosure parts and any parts of the invention. Also as describe in (10), (11).

8. The invention defines spaces within and on it. Also as describe in (12), (30).

9. The invention can be prefabricated and modular. Also as describe in (13).

10. The invention can be the building blocks for the construction. Also as describe in (14), (16), (30).

11. The invention can be designed to be deployed anywhere and its functions can be designed to accommodate any purposes or technologies for the benefits of human civilisation. Also as describe in (15), (17), (18), (19), (20), (21), (22), (30).

12. The invention by itself or as multiple units can be used for dwelling, manufacturing, warehousing, data-centers, delivery drone-deployment systems, renewable energy farming and much more without limitations on the purposes the invention can be used or adapted for. Also as describe in (15), (17), (18), (19), (20), (21), (22), (30).

13. The idea is to construct spaces in the ocean, seas or water bodies. This does not form any constraints for the invention to be used anywhere else.

14. The invention can be adapted and customized. Also as describe in (28), (29), (30).

15. (31) The invention can have build in support systems for the building, dwelling, urban systems for human civilisation.

16. (32) The invention can be sequentially connected in way that multiple modules of the invention can be connected one after another in sequence to achieve a larger structure.

17. (33) The invention can be subsequently connected in way that additional modules of the invention can be additionally connected to existing structures previously build up with modules of the invention.
